(19) United States
(12) Patent Application Publication
(10) Pub. No.: US 2026/0194000 A1
(43) Pub. Date: Jul. 9, 2026

(54) NOZZLE DESIGNS FOR SECONDARY AIR INJECTION IN EXHAUST AFTERTREATMENT SYSTEMS WITH ELECTRICAL HEATERS

(71) Applicant: CORNING INCORPORATED, CORNING, NY (US)

(72) Inventors: Bertrand Luc Coulet, Wiesbaden (DE); Konstantin Vladimirovich Khodosevich, Espoo (FI); Egor Kuznetsov, Saint Petersburg (RU)

(21) Appl. No.: 19/133,064

(22) PCT Filed: Nov. 17, 2023
(86) PCT No.: PCT/US2023/080185

§ 371 Date: May 27, 2025

Related U.S. Application Data
(60) Provisional application No. 63/428,486, filed on Nov. 29, 2022.

(51) Int. Cl. F01N 3/32; B01D 46/00; B01D 46/24; B01D 46/42; B01D 53/94; F01N 3/022; F01N 3/28; F01N 3/30

(52) U.S. Cl. CPC F01N 3/32; B01D 46/0041; B01D 46/2418; B01D 46/4263; B01D 53/94; F01N 3/0222; F01N 3/2828; F01N 3/306; B01D 2258/01; B01D 2279/30; F01N 2240/16; F01N 2330/06; F01N 2370/02

(57) ABSTRACT

An aftertreatment system may include an exhaust pipe and a mixing pipe. The exhaust pipe receives exhaust gas from an engine. The mixing pipe is disposed in the exhaust pipe and may include a tubular portion and a plurality of blades extending from a longitudinal end of the tubular portion. The tubular portion may include a plurality of openings extending through inner and outer diametrical surfaces of the tubular portion. The tubular portion and the plurality of blades may define an integrally formed unitary body.

### CROSS-REFERENCE TO RELATED APPLICATION

This application claims the benefit of priority under 35 U.S.C. § 119 of U.S. Provisional Application Ser. No. 63/428,486 filed on Nov. 29, 2022, the content of which is relied upon and incorporated herein by reference in its entirety.

### FIELD

This disclosure relates to exhaust aftertreatment systems, such as internal combustion engine exhaust aftertreatment systems, more particularly to exhaust aftertreatment systems having electrical heaters, and even more particularly to exhaust aftertreatment systems having electrical heaters and secondary air injection.

### BACKGROUND

Temperature control can be useful during the treatment of fluid streams. For example, catalytic materials can be used in the treatment of fluid flows, such as in the aftertreatment of the exhaust of an internal combustion engine, such as the internal combustion engine of an automobile. Catalytic activity of such materials may not initiate until the catalytic material reaches some minimum threshold temperature, which may be referred to as the light-off temperature. Overall emissions can be reduced by minimizing the amount of time the catalyst is below its light-off temperature while the engine is in operation. Electrical heaters provide one manner for assisting in control of temperature during treatment of a fluid stream, such as to increase the temperature of a catalyst material.

### SUMMARY

Disclosed herein are secondary air injection systems for exhaust after treatment systems. In embodiments, a secondary air injection system for an exhaust aftertreatment system comprises a nozzle positioned within exhaust piping of the exhaust aftertreatment system, wherein the nozzle comprises a tubular side wall extending in a longitudinal direction and having an inner width that defines a flow passage to direct secondary air through the nozzle in an axial flow direction that is parallel to the longitudinal direction, the first inner width extending in a lateral direction perpendicular to the axial flow direction; an outlet end having an inner end surface within the flow passage that extends transversely with respect to the axial flow direction of the secondary air within the nozzle; a first set of openings in the tubular side wall through which a first portion of the secondary air exits the nozzle in directions transverse to the axial flow direction; and a second set of openings in the inner end surface through which a second portion of the secondary air exits from the nozzle in the axial flow direction; wherein the inner end surface spans a second inner width in the lateral direction that is at least 50% of the first inner width.

In embodiments, a flow rate of the secondary air through the nozzle is from 10 kg/h to 60 kg/h.

In embodiments, a flow rate of the secondary air through the nozzle is from 20 kg/h to 45 kg/h.

In embodiments, the inner end surface is a flat surface that extends perpendicularly to the axial flow direction.

In embodiments, the second inner width of the inner end surface is equal to the first inner width.

In embodiments, the second set of openings occupies at least 5% of an inner area of the inner end surface at least partially by the second inner width.

In embodiments, the second set of openings occupies at most 30% of an inner area of the inner end surface at least partially by the second inner width.

In embodiments, the second set of openings occupies from 5% to 30% of an inner area of the inner end surface defined at least partially by the second inner width.

In embodiments, the second set of openings occupies from 8% to 20% of an inner area of the inner end surface at least partially by the second inner width.

In embodiments, the inner end surface comprises a central area having a third width in which none of the second set of openings are located.

In embodiments, the third width of the central area is at least 25% of the first width.

In embodiments, the third width of the central area is at least 30% of the first width.

In embodiments, the third width of the central area is at least 40% of the second width.

In embodiments, the third width of the central area is at least 50% of the second width.

In embodiments, the system comprises a pump in fluid communication with ambient air that is configured to force the ambient air through the nozzle as the secondary air.

Also disclosed herein are exhaust aftertreatment systems comprising the secondary air injection system of any of the preceding paragraphs, a heater, and an aftertreatment component, wherein the heater is located downstream of the nozzle, and the aftertreatment component is located downstream of the heater.

In embodiments, the aftertreatment component comprises a honeycomb body arranged as a particulate filter or catalyst substrate.

Also disclosed herein are methods of uniformly providing heat to a downstream aftertreatment component in an exhaust aftertreatment system. In embodiments, a method of uniformly providing heat to a downstream aftertreatment component in an exhaust aftertreatment system comprises injecting secondary air into exhaust piping of the exhaust aftertreatment system via a secondary air injection nozzle; generating heat with a heater assembly of the exhaust aftertreatment system; flowing the secondary air through the exhaust piping to the heater assembly to heat the secondary air with the heater; and flowing the heated secondary air from the heater assembly to an aftertreatment component located downstream of the heater assembly to heat the aftertreatment component; wherein an average velocity of the secondary air across an upstream face of the heater assembly is at least 70% of a maximum flow rate at the upstream face of the heater assembly.

In embodiments, the secondary air injection nozzle comprises the secondary air injection nozzle of any one of the above paragraphs.

In embodiments, the aftertreatment component comprises a honeycomb body arranged as a particulate filter or catalyst substrate.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is cross-sectional side view of a portion of an exhaust aftertreatment systems comprising a secondary air injection nozzle according to embodiments herein.

FIG. 2 is a cross-sectional side view of a secondary air injection nozzle according to one embodiment disclosed herein.

FIG. 3 is a perspective view of the secondary air injection nozzle of FIG. 2.

FIG. 4 is an end view of the secondary air injection nozzle of FIG. 2.

FIGS. 5A-5F illustrate different nozzles according to various nozzle designs assessed via computer modeling and simulation as described herein.

FIG. 6 shows an image of a portion of a test setup used to test different nozzle designs for flow and temperature uniformity as described herein.

FIGS. 7A-7C show the terminal end and side wall of three nozzle designs tested with the test setup of FIG. 6 as described herein.

FIG. 8 is a graph showing the temperature at various locations of a honeycomb body located downstream of the test setup of FIG. 6 when used in conjunction with each of the nozzle designs of FIGS. 5A, 7A, 7B, and 7C, as described herein.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

Fluid treatment systems, such as automobile exhaust aftertreatment systems, can comprise a supplemental source of heat to facilitate faster catalyst light-off, particularly in comparison to catalyst-containing aftertreatment systems that do not have any supplemental heat (e.g., instead relying on the heat of the engine exhaust). For example, heat can be supplied by an electric heater (e.g., arranged to transfer heat to the catalyst material) or an electrically heated catalyst substrate (e.g., an electrically conductive substrate that is carrying a catalytic material). For example, a heater can be arranged upstream of a catalyst substrate and heat the catalyst by providing heat to the flow of exhaust (or supplemental air), which in turn heats the catalyst. Aftertreatment systems employing supplemental heat can be provided to reduce emissions in gasoline, diesel, and/or hybrid vehicles to assist in ensuring fast and consistent light-off of the catalyst during operation of the corresponding engine, particularly after cold-start of the engine.

In various embodiments, exhaust aftertreatment systems comprising both electrical heaters and supplemental air injection are disclosed. While electrical heaters can be useful for providing additional heat to reduce the time it takes a catalytic material to reach its light off temperature, some systems may benefit from supplemental airflow, which may be referred to as the injection of secondary air, to assist in transferring the heat generated by the heater to the catalytic material. For example, the secondary air can be used to create an airflow while the exhaust flow from an internal combustion engine is still below some minimum threshold. For example, the secondary air injection can be controlled so that it is provided before the internal combustion engine is operating or in some initial time period directly following initiation of the internal combustion engine, e.g., immediately after cold start of the engine. Once the exhaust flow from the engine becomes established (e.g., reaches a steady-state during engine operation), the need for secondary air injection may no longer be necessary, as the heat generated by the upstream heater can be carried by the exhaust flow and/or the heater may no longer be needed as the exhaust flow itself exiting from the hot engine has a sufficiently high temperature to maintain the catalyst above its light-off temperature.

In particular, embodiments herein provide secondary air injection nozzle designs that provide for uniform gas flow distribution, which leads to more uniform heater temperature distribution to the downstream aftertreatment component (e.g., to a substrate or filter) and, as the result, to a better exhaust aftertreatment system performance. The nozzle designs disclosed herein utilizes an inner end surface with holes distributed along its surface to ensure the axially direction flow through the nozzle is split and redirected into sufficient axial and lateral flow portions. Accordingly, the nozzle designs disclosed herein advantageously improve the homogeneity of the flow at the electrical heater and at downstream aftertreatment component, and therefore improves the overall performance of the exhaust aftertreatment system. The nozzle designs used herein can be utilized in exhaust aftertreatment systems comprising any type of electrical heater, such as a resistance heater or induction heated body.

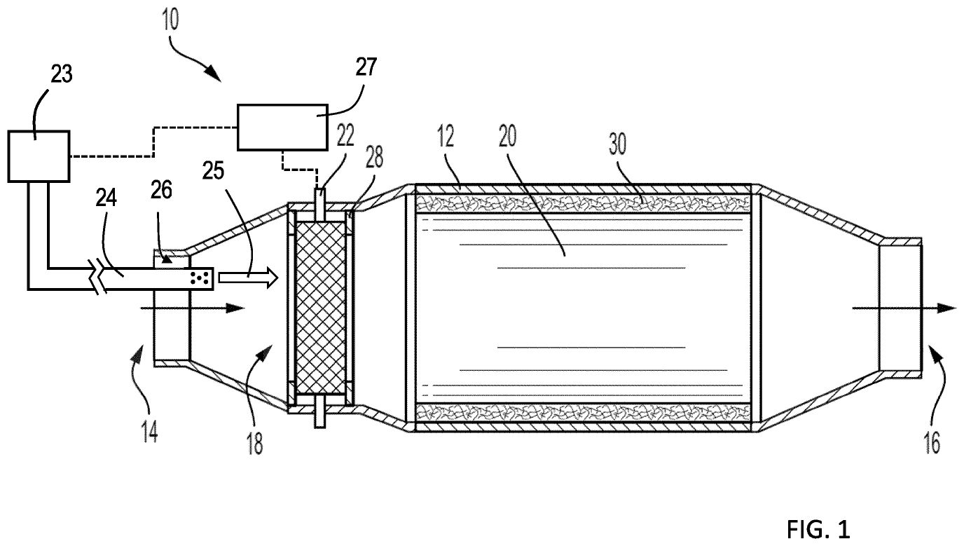

Referring now to FIG. 1, a portion of a fluid treatment system 10 is illustrated, e.g., which can be arranged as part of an exhaust system of automobile. The fluid treatment system 10 comprises an outer housing 12 (which may be alternatively referred to as a “can”), such as formed in a generally tubular shape (e.g., a hollow tube) from metal or suitable material. The tubular housing 12 has an inlet 14, e.g., which can be connected in fluid communication with the exhaust manifold of an internal combustion engine, and an outlet 16, e.g., which can be connected in fluid communication with an output, such as a tailpipe of an automobile. Accordingly, the housing 12 can be connected as part of an exhaust pipe or piping system that runs from the engine exhaust manifold to an output, such as a tailpipe.

Exhaust from an engine can be treated (e.g., one or more pollutants removed or abated) as the exhaust is flowed from the inlet 12 to the outlet 14 through the system 10. To this end, the system 10 further comprises a heater assembly 18 and an aftertreatment component 20 located between the inlet 12 and outlet 14. For example, the aftertreatment component 20 can be a catalyst-loaded substrate, a particulate filter, or a catalyst-loaded particulate filter. For example, catalyst substrates and particulate filters can comprise a porous ceramic honeycomb body having an array of walls that form a plurality of fluid flow paths or channels extending axially (in the direction of exhaust flow and/or perpendicular to the end faces of the body) through the body.

As described in more detail herein, the heater assembly 18 can be a resistance heater that provides supplemental heat to facilitate functionality of the aftertreatment component 20, e.g., by quickly initiating light-off of catalytic material disposed in or on the walls of the heater assembly 18 and/or the aftertreatment component 20. For example, the heater assembly 18 can comprise, or otherwise be connected to, electrodes 22. The electrodes 22 can be arranged extending through the housing 12 in order to connect the heater assembly 18 to a power source, such as a vehicle battery. As shown in FIG. 1, the electrodes 22 can extend radially through the housing 12. However, the electrodes 22 can alternatively extend axially through the housing 22. In this way, the heater assembly 18 can be arranged to generate heat via Joule heating when the heater assembly 18 is connected to a power source and a corresponding voltage is applied to flow current through the walls of the heater assembly 18. The electrodes 22 are shown in FIG. 1 as being arranged on opposite sides of the heater assembly 18 (e.g., spaced 180° apart with respect to the exterior of the heater assembly 18), but can be arranged at other locations or angles.

In some embodiments, such as shown in FIG. 1, the heater assembly 18 is positioned upstream of the aftertreatment component 20 in order to increase the temperature of the exhaust flow and/or provide direct heating to the aftertreatment component 20, which in turn increases the temperature aftertreatment component 20, such as the temperature of the catalytic material carried by the aftertreatment component 20 as the exhaust flows through the aftertreatment component 20. In some embodiments, the heater assembly 18 and the aftertreatment component 20 can be effectively combined into a single device by directly loading the body of the heater assembly 18 with a catalyst. Such arrangements useful for heating a catalyst material may be referred to as an electrically heated catalyst, or EHC.

To assist in providing heat from the heater assembly 18 downstream to the aftertreatment component 20, the system 10 can comprise an injection nozzle 24 that provides a flow of secondary air 25 into the system 10. For example, the injection nozzle 24 can comprise a plurality of openings 26, described in more detail below, through which the secondary air 25 flows. Although not shown in FIG. 1, the nozzle 24 can be arranged so that it extends through the housing 12 in order to provide the secondary air 25 from a source external to the system 10, such as from ambient air provided by a pump 23 into and through the nozzle 24. For example, control of the flow of secondary air 25 through the nozzle 24 (e.g., control of a pump forcing air through the nozzle 24) can be controlled by a control unit 27, such as an electronic control unit (ECU) for the vehicle in which the system 10 is installed. Likewise, the control unit 27 can be configured to control operation of the heater assembly 18. For example, the control unit 27 can be configured to operate the heater assembly 18 when supplementary heat is desired for the system 10 and to produce the flow of secondary air 25 when additional air flow is desired to assist in transferring the heat generated by the heater assembly 18 to the aftertreatment component 20, such as during an initial time period after an internal combustion engine connected to the system 10 is first turned on (e.g., during cold start).

The flow of secondary air 25 exits the nozzle 24 and then flows through the heater body of the heater assembly 18, which causes the flow of secondary air 25 to be heated by the heater assembly 18. The heated secondary air 25 then flows further downstream to the aftertreatment component 20, which in turn heats the aftertreatment component 20, e.g., including any catalyst material carried by the aftertreatment component 20. In this way, the heat generated by the heater assembly 18 can be effectively transferred to the aftertreatment component 20 via the secondary air 25 provided by the nozzle 24. For example, this can be used to facilitate catalyst material carried by the aftertreatment component 20 quickly reaching its light-off temperature, as described herein.

The exhaust system 10 can comprise additional lengths of piping (not shown) connected at the inlet 14 (e.g., extending between the inlet 14 and the engine exhaust manifold) and outlet 16 (e.g., extending from the outlet 16 to the tail pipe). Depending on the design or configuration of the exhaust system, which may vary system to system (e.g., vehicle to vehicle), the various components and/or lengths of piping can have different diameters at different positions along the flow path through the exhaust system. In this way, the inlet and outlet ends 14, 16 can be used to facilitate connection of the system 10 between exhaust piping of different diameters. In other embodiments, one or both of the upstream and downstream ends 14, 16 can have substantially the same diameter as the lengths of piping to which they are connected. In some embodiments, such as shown in FIG. 1, the housing 12 transitions between different diameters at the heater assembly 18 and the aftertreatment component 20. However, in other embodiments, the housing 12 can be substantially the same dimension at both the heater assembly 18 and the aftertreatment component 20, e.g., such as in embodiments in which the heater assembly 18 and the aftertreatment component 20 have the same diameter.

The heater assembly 18 and the aftertreatment component 20 can be held in place, supported, and/or contained within the housing 12 in any suitable manner. For example, the body of the heater assembly 18 can be held in place and supported via one or more retainers 28, e.g., retaining rings. The aftertreatment component 18 can be supported by similar retainers and/or supported by a mat 30, such as an inorganic fiber mat, which assists in protecting the aftertreatment component, such as from vibrations or thermal expansion forces exerted on the aftertreatment component 20.

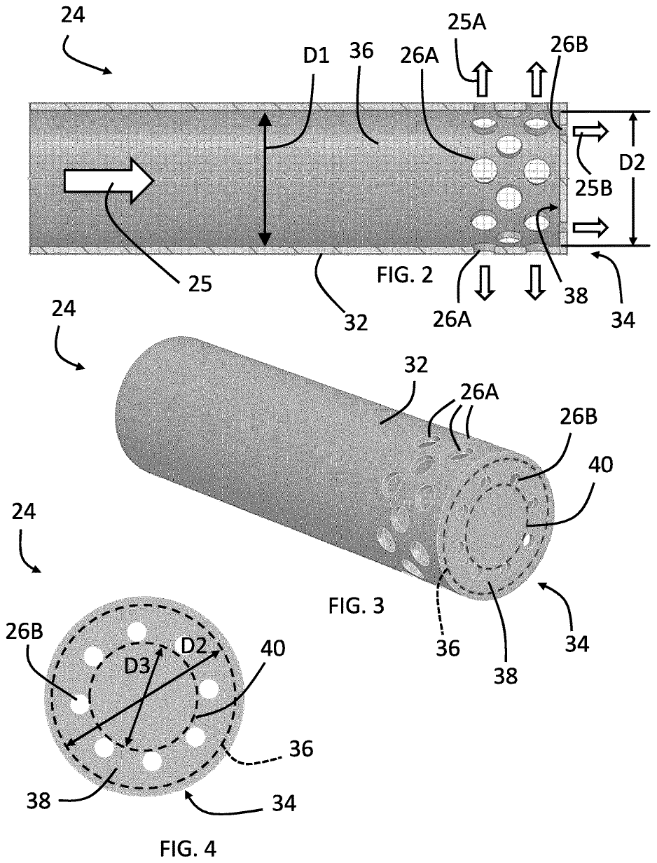

An embodiment of the injection nozzle 24 can be appreciated in view of FIGS. 2-4. As shown most clearly in the cross-sectional view of FIG. 2, the injection nozzle 24 comprises a tubular side wall 32 that extends in a longitudinal direction until a terminal end 34. The center line of the tubular side wall 32 of the nozzle 24 is illustrated in FIG. 2, which extends along the longitudinal direction. The tubular side wall 32 has an inner width D1 (e.g., an inner diameter when the tubular side wall has a cylindrical shape) that defines a flow passage 36 for directing the flow of secondary air 25 through the nozzle 24 in a primary flow direction that is parallel to the longitudinal direction of the nozzle, and which may be referred to as an axial flow direction (as indicated by the direction of the arrow used in FIG. 2 to designate the secondary air 25). The inner surface of the tubular side wall 32 defining the flow passage 36 is identified and illustrated by a dashed line in FIGS. 3 and 4.

As described in more detail herein, the terminal end 34 comprises an inner end surface 38 that extends transversely with respect to the longitudinal direction through the nozzle 24 within the flow passage 36. For example, as illustrated in the embodiment illustrated in FIG. 2, the inner end surface 38 is preferably a flat surface that extends perpendicularly with respect to the axial flow direction of the secondary air 25 through the nozzle 24. However, the inner end surface 38 does not necessarily need to be completely flat, for example, the inner end surface 38 may have a slight concavity or convexity. In any event, the inner end surface 38 spans a second inner width for the nozzle, which may be understood as lateral distance in a plane perpendicular to the axial flow direction, and designated in FIGS. 2-4 as a lateral width D2.

In the embodiment of FIGS. 2-4, the lateral width D2 of the inner end surface 38 is the same as the inner width D1 of the tubular side wall 32 that defines the flow passage 36. In other embodiments (such as those described below), the width D2 can be greater than or less than the width D1, e.g., if the nozzle 24 tapers inwardly or outwardly at the terminal end 34. For example, in embodiments in which D2 is less than D1, the side wall 32 may taper inwardly proximate to the terminal end 34. When the side wall 32 includes a taper, the width D1 can be taken as the primary width of the flow passage 36 before the tapering begins. As referred to further hereinbelow, the inner end surface 38 has an area (inside the nozzle 24, bounding the flow passage 36) that is defined by its width D2 (and/or other dimensions, e.g., by two widths if the inner end surface 38 has a rectangular shape). For the purposes of disclosure herein, the area of the inner end surface 38 is considered as the total area of the inner end surface 38, inclusive of any areas of the inner end surface 38 through which the openings 26B are formed.

The general location of the inner end surface 38 is labeled in FIGS. 3 and 4, although it is to be appreciated that the inner end surface 38 cannot actually be seen in those figures since the inner end surface 38 is located within the nozzle 24 at the terminal end of the flow passage 36. In embodiments, the inner end surface 38 can comprise a central area 40 that spans a lateral width D3 in the lateral direction perpendicular to the axial flow direction in which none of the openings 26 are located. The general location corresponding to the central area 40 is identified in FIGS. 3 and 4, although, similar to the inner end surface 38, the central area 40 is located internally within the flow passage 36 of the nozzle 24 and thus cannot actually be seen in FIGS. 3 and 4.

In the embodiment of FIGS. 2-4, the openings 26 comprise a first set of openings 26A in the tubular side wall 32 and a second set of openings 26B at the terminal end 34 and through the inner end surface 38. In embodiments, the total flow rate of the secondary air 25 (i.e., the first portion 25A summed with the second portion 25B) is about 30 kg/h, such as from 10 kg/h to 60 kg/h, or from 20 kg/h to 45 kg/h. The first set of openings 26A permit a first portion 25A of the secondary air 25 to exit laterally or radially from the nozzle 24, i.e., in directions radiating out from the nozzle 24 transversely, e.g., perpendicularly, with respect to the axial flow direction through of the tubular side wall 32. While the term “radial” may be used herein, it is not limited to circular cross-sections for the tubular side wall 32, and thus should be considered interchangeably to the term “lateral” as referring to any transverse or perpendicularly outward direction regardless of cross-sectional shape of the nozzle.

In contrast to the first set of openings 26A, the second set of openings 26B permits a second portion 25B of the secondary air 25 to exit axially from the nozzle 24, i.e., in a direction generally parallel to the flow direction of the secondary air 25 and/or the longitudinal direction defined by the tubular side wall 32 of the nozzle 24. The second set of openings 26B are formed at the terminal end 34 and extend through the inner end surface 38. At least some of the total area of the inner end surface 38 (as defined above) is occupied by the second set of openings 26B.

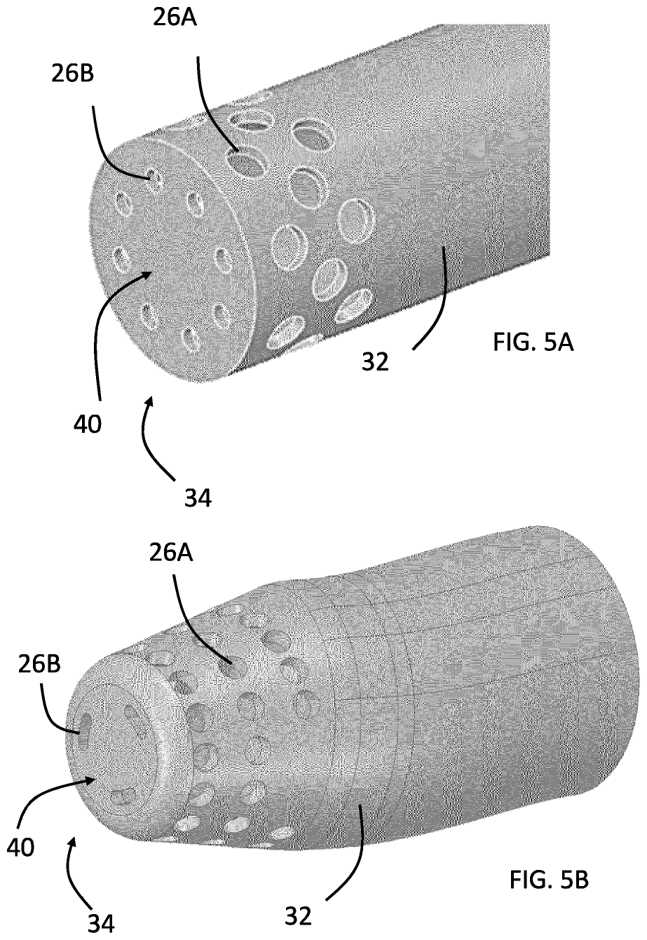

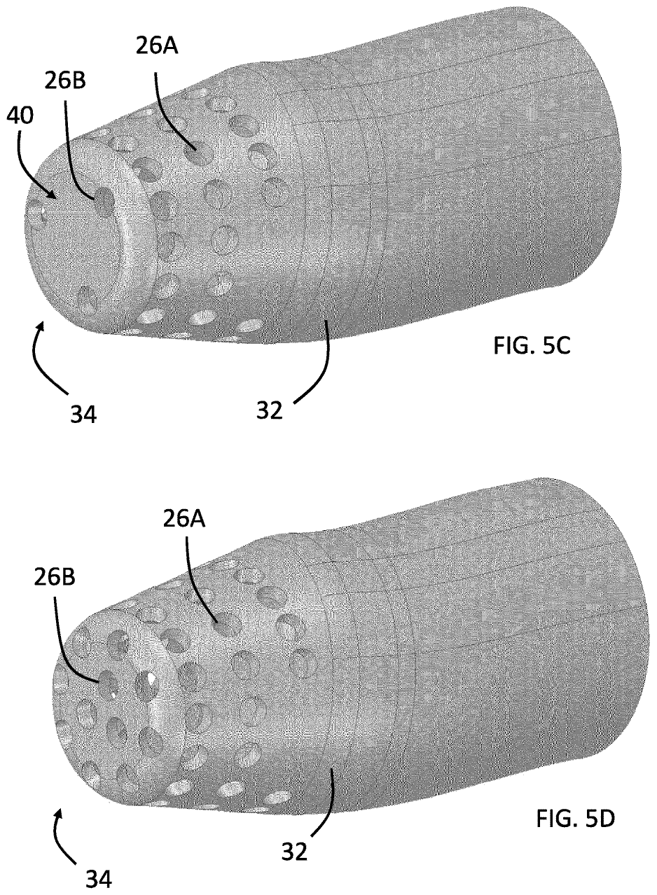

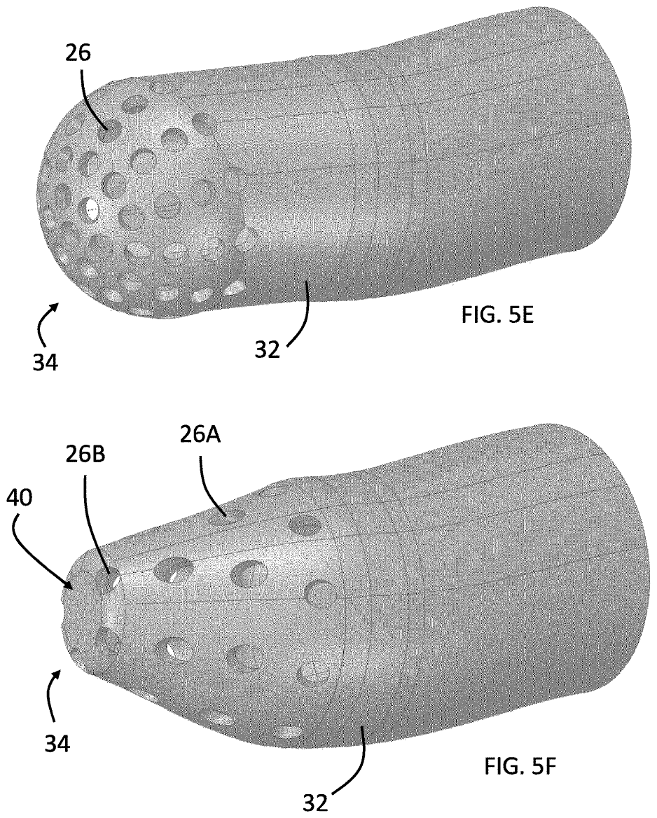

FIGS. 5A-5F illustrate various nozzle arrangements that were modeled and evaluated using computerized simulation. Each of the embodiments of FIGS. 5A-5F were evaluated in a modeled exhaust system similar in respects to that illustrated in FIG. 1 with the corresponding secondary air injector nozzle of FIG. 5A-5F located upstream of a modeled heater (e.g., akin to the heater 18 in FIG. 1). The nozzles were modeled upstream of the heater to evaluate the cross-sectional uniformity of flow across the upstream face of the heater as the secondary air flows through the heater. The flow uniformity represents how velocity varies over the front face of the heater, where a value of one indicates the highest uniformity. In particular, the flow uniformity was determined as the normalized root mean square of the difference between a local velocity and the area mean of the velocity across the front face of the heater. Accordingly, the flow uniformity can be understood to correspond ultimately to the uniformity of heat transfer downstream of the heater, e.g., to the uniformity by which the heater 18 is able to heat a downstream substrate (e.g., the aftertreatment component 20 of FIG. 1) when a heater is used with each of the nozzle designs. The computer simulations were performed at a constant simulate flow rate of 30 kg/h for secondary air through each of the respective nozzle designs. The nozzle designs and flow uniformity results are summarized in Table 1 below, with the Figure number in which each nozzle design is illustrated also used to identify that corresponding nozzle design (e.g., nozzle design 5A is shown in FIG. 5A). The nozzle designs are ranked in Table 1 with most uniformity at the top to least uniformity at the bottom, with the average flow velocity at the upstream face being at least 70% of the maximum flow velocity for each of the designs 7A, 7B, and 7C indicating particularly good uniformity performance for these designs.

TABLE 1

| | | Inner | Central | |
|---|---|---|---|---|
| | | End | Area | End Area |
| Nozzle | Flow | Surface | Size With No | Occupied by |
| Design | Uniformity | Size | Openings | Openings |
| 5A | Excellent | Large | Large | Medium |
| | | (D2 = | (D3 ≥ 0.5*D1 | (8 openings) |
| | | D1) | D3 ≥ 0.5*D2) | |
| 5B | Very Good | Medium | Medium | Medium/Low |
| | | (D2 ≥ | (D3 < 0.5*D1 | (3 openings) |
| | | 0.5*D1) | D3 ≥ 0.5*D2) | |
| 5C | Good | Medium | Medium | Low |
| | | (D2 ≥ | (D3 < 0.5*D1 | (3 openings) |
| | | 0.5*D1) | D3 ≥ 0.5*D2) | |
| 5D | Average | Medium | None | Very high (11 |
| | | (D2 ≥ | | openings, >30% |
| | | 0.5*D1) | | area) |
| 5E | Poor | n/a | n/a | n/a |
| 5F | Poor | Small | Small | Very high (6 |
| | | (D2 < | | openings, >30% |
| | | 0.5*D1) | | area) |

In addition to the physical features of the nozzles, the Reynold's numbers associated with each of the designs of FIGS. 5A-5F were also assessed. In particular, Table 2 summarizes the Reynolds number corresponding to flow through the openings 26B in the end surface 38 (abbreviated as Re_{end}) the Reynolds number corresponding to flow through the openings 26A in the side wall 32 (abbreviated as Re_{side}), and the ratio of the Reynolds numbers (abbreviated as the Re ratio).

TABLE 2

| | | End | Side | |
|---|---|---|---|---|
| | | openings | openings | |
| Nozzle | Flow | Reynolds | Reynolds | |
| Design | Uniformity | number | number | Re ratio |
| 5A | Excellent | 3474 | 5593 | Re_{end} < Re_{side}, |
| | | | | moderate values |
| 5B | Very Good | 3425 | 3339 | Re_{end} ≈ Re_{side}, |
| | | | | moderate values |
| 5C | Good | 4922 | 3290 | Re_{end} > Re_{side}, |
| | | | | moderate values |
| 5D | Average | 4484 | 2443 | Re_{end} > Re_{side}, |
| | | | | moderate values |
| 5E | Poor | n/a | n/a | |
| 5F | Poor | 7276 | 7756 | Re_{end} ≈ Re_{side}, |
| | | | | Very high |
| | | | | values |

From Tables 1 and 2, the overall most uniform flows were consistently seen by those nozzle designs with larger inner end surfaces (i.e., larger lateral widths D2 for the inner end surface 38), particularly relative to the cross-sectional flow area through the nozzle (i.e., relative to the inner width D1 of the nozzle 24). For example, design 5A having the value of its lateral width D2 approximately equal to D1 exhibited the best performance, while designs 5B-5D, all having a medium sized inner end surface (i.e., their lateral widths D2 at least half the inner width D1), ranged in uniformity from good to average performance. Designs 5E and 5F, which had extremely small or no inner end surface (that is, the width D2 cannot be determined for design 5E), rated the worst in uniformity.

Overall better uniformity was also seen when the nozzle design had a relatively larger size of the central area (i.e., the width D3) of the inner end surface that was not occupied by any openings. For example, design 5A again had the highest uniformity with a large central area size (i.e., the width D3 being at least one half of the size of both widths D1 and D2), while the designs 5B-5C having a medium sized central area (i.e., width D3 being at least one half width D2 but less than one half of the width D1) ranged from very good to average in uniformity performance. Design 5D, having no appreciable central area (negligibly small width D3) still yielded average performance. Designs 5E and 5F having small to no central areas (width D3 is much smaller than width D1 in design 5E, and width D3 cannot be determined for design 5F) again rated the worst in uniformity performance.

As summarized in Table 2, the Re ratio was generally correlated to improved uniformity, as the two most uniform designs, 5A and 5B, had a Reynolds number for the openings 26A in the side wall that was at least approximately as large as the Reynolds number for the openings 26B in the end surface (Re_{end}≈Re_{side} for design 5B and Re_{end}<Re_{side} for 5A). However, the Re ratio was not solely dipositive in indicating performance, as design 5F also resulted in a Reynolds number for the side wall openings 26A that was greater than the Reynolds number for the openings 26B in the end surface (Re_{end}<Re_{side}), but was generally the least uniform. Instead, it can be seen that the more moderate Reynolds numbers for designs 5A-5D performed better than the comparatively high Reynold's numbers for the design 5F.

Lastly, better overall uniformity was also seen for nozzles having sufficient flow area through the inner end surface (i.e., total area of the openings 26 in the inner end surface 38) while still maintaining a relatively larger size of the central area described above. In general, there needed to be sufficient total flow area of the openings, with performance generally increasing from a low total area of occupied by openings (design 5C) to a medium area occupied by the (designs 5A and 5B). However, too high of the area occupied by the openings resulted in generally poorer performance. For example, designs 5D and 5F having very high percentages of the area of the inner end surface occupied by openings (i.e., over 30% of the inner end surface occupied by openings) had only average to poor uniformity performance, while the remaining designs performed more uniformly.

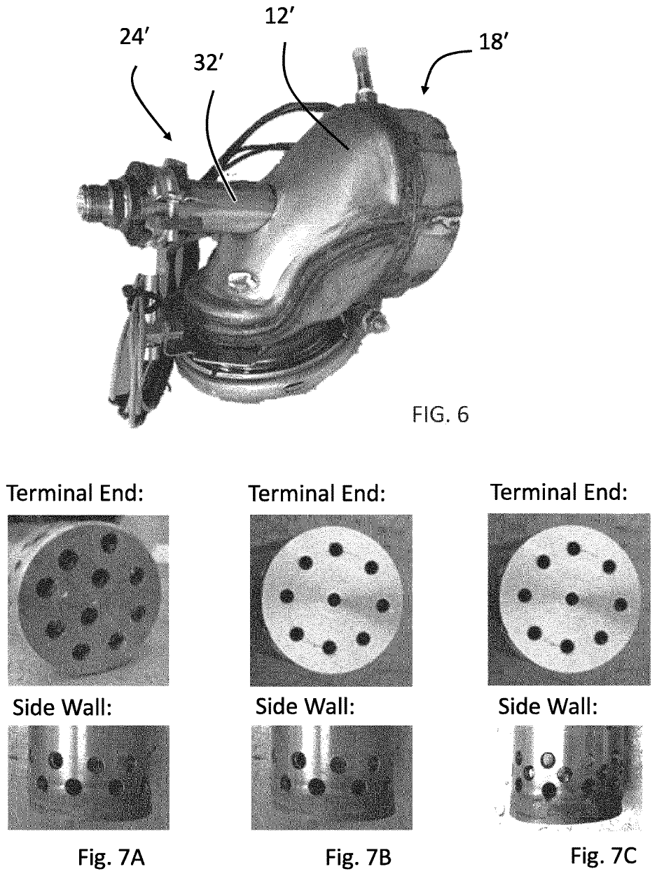

In another test, a nozzle in accordance with the nozzle design 5A and three additional nozzle designs generally resembling the design 5A were fabricated and installed on an aftertreatment system test setup shown in FIG. 6 as aftertreatment system test setup 10′. In general, the test setup components are provided with their base reference numerals from FIG. 1 by appended with a prime symbol (′) to designate them as test components. As shown in FIG. 6, the test tubular housing 32′ of the test nozzles 24′ were inserted through a bend or elbow of the test housing 12′ (such a bend or elbow not shown in FIG. 1) in order to provide flow of secondary air to the test heater 18′. The test heater 18′ was therefore installed downstream of terminal end of the test nozzle 24′ (which cannot be seen in FIG. 6 as the terminal end is located inside of the test housing 12′). The nozzle 24′ and test heater 18′ were positioned upstream of a honeycomb body (e.g., akin the aftertreatment component 20) that was equipped with six thermocouples at different locations across its upstream face (the face of the honeycomb body facing the heater 18′) in order to measure the temperature at each of these six locations and therefore determine the uniformity of flow of secondary air from each tested nozzle through the heater disc and thus the uniformity of heat transfer downstream.

The other three nozzle designs that were tested are shown in FIGS. 7A-7C and will be referred to herein correspondingly as designs 7A, 7B, and 7C. Each of FIGS. 7A-7C illustrates both the terminal end and the sidewall of the corresponding nozzle design. In particular, FIG. 7A illustrates a nozzle design that generally resembles that of FIG. 5A, but where two additional openings (akin to the openings 26B) have been provided in the center of the terminal end 34, such that the nozzle design 7A does not comprise the central area 40. In FIG. 7B, the nozzle design 7B also lacks the central area 40, but by way of only a single additional opening instead of two additional openings as in FIG. 7A. The nozzle design 7C of FIG. 7C had the same terminal end as design 7B, but with an additional row of openings in the side wall (three rows in 7C as opposed to only 2 rows in designs 7A and 7B).

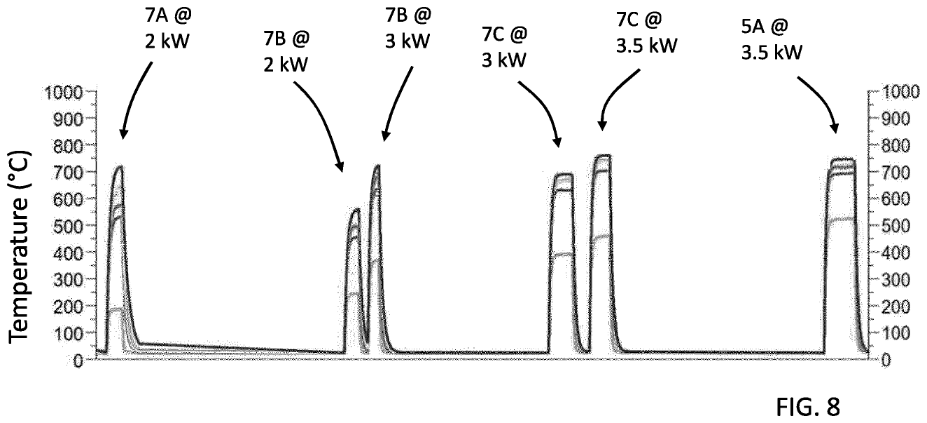

FIG. 8 illustrates the performance of each of the nozzle designs tested on the setup of FIG. 6. It is noted that the x-axis of FIG. 8 corresponds to time, and thus only represents the amount of time each test was run and/or the time between tests (and is therefore not particularly pertinent to assessing the performance of these of the tested nozzles). Instead, performance can be assessed with respect to the data plotted on the y-axis, with each of the data lines corresponding to a different of the six thermocouples, and therefore, to six different locations on the downstream honeycomb body. Accordingly, the nozzles with the most uniform flow distribution are those that have the closest clustering of all of the data lines in each test. The nozzle design number (corresponding to the Figure) and power at which the heater 18′ was run, in kilowatts (kW) are identified in FIG. 8 for each test.

In the first test (corresponding to the left-most peak of FIG. 8), the nozzle design 7A (thus, that shown in FIG. 7A) was utilized with the heater 18′ at 2 kW. In this test, the temperatures of the six location were quite spread out, with the hottest being just above about 700° C. and the coldest being only about 200° C., indicating that the nozzle design 7A had significant non-uniformity. In the next test, the design 7B was utilized also at 2 kW. This resulted in a significant decrease in maximum temperature, but a significant increase in minimum temperature, with temperatures ranging from about 550° C. to 250° C., which overall resulted in a meaningful increase in uniformity. Consistent with the description herein regarding the central area 40, it is believed that the additional openings for designs 7A and 7B in what was the central area 40 of design 5A resulted in a significant hotspot from an excess of axial flow. Correspondingly, reducing the number of openings in the central location from two (design 7A) to one (design 7B) resulted in a reduction of this central hot spot.

As shown in the next two peaks, nozzle designs 7B and 7C were next tested with the heater 18′ running at 3 kW of power. Despite the extra row of openings in the sidewall of design 7C (an extra row of the openings 26A), the downstream temperature uniformity was nearly identical in these tests. Accordingly, it is believed that once a sufficient number of side wall openings are provided, additional openings have little effect on overall performance.

Next, the nozzle design 7C and the nozzle design 5A were both tested with the heater 18′ run at 3.5 kW of power. It was seen that the nozzle design 5A, which has the central area 40 as described above, had better temperature uniformity performance than design 7C, which did not have the central area 40 (due to the additional opening located at the center of the terminal end of the design 7C, as shown in FIG. 7C). That is, the temperature data for design 5A ranged from about 750° C. to about 525° C., while the temperature data for design 7C ranged from about 750° C. to only about 450° C. Again, it is believed that the presence of the central area 40 in which there are none of the openings 26, as in design 5A, results in consistently better downstream temperature uniformity performance due to the sufficient splitting and redirection of flow laterally through the side wall, which results in a more uniform secondary air flow through the heater.

Accordingly, nozzles disclosed herein can be set with respect to the size of the inner end surface 38 in the lateral direction (i.e., certain minimum size for the width D2), threshold for the size of the central area 40 in which there are none of the openings 26, and minimum and maximum amount of area occupied by the openings 26 in the inner end surface 38. Without wishing to be bound by theory, it is believed that the presence of a relatively larger inner end surface 38, relatively larger center area 40, and balanced total area occupied by the openings 26 in the inner end surface 38 can be used to at least partially hinder some of the flow of the secondary air 25 in the axial direction in order to build pressure within the nozzle 24 and redirect at least some of the flow laterally. In other words, these features summarized with respect to Table 1 and FIGS. 5A-5F can be used to balance the proportion of the first portion 25A and the second portion 25B to ensure uniformity of the flow of secondary air 25 reaching the heater 18, and therefore, improve the uniformity of temperature transfer to the downstream aftertreatment component 20 (e.g., catalyst substrate or filter).

In embodiments, the width D2 is at least 25%, at least 30%, at least 35%, at least 40%, or even at least 50% of the width D1, up to equal in size to the width D1 (100% of the width D1), including ranges having these values as end points, such as at least 25% to 100%, at least 40% to 100% or even at least 50% to 100%. In embodiments, the width D3 of the center section 40 of the inner end surface 38 is at least 40%, at least 50%, or even at least 60% of the width D2 of the inner end surface 38 including ranges having these values as end points, such as from 40% to 70% of the width D1. In embodiments, the width D3 of the center section 40 of the inner end surface 38 is at least 25%, at least 30%, at least 40%, or even at least 50% of the width D1, including ranges having these values as end points, such as from 25% to 60% of the width D1 of the flow passage 36. In embodiments, the second set of openings 26B occupies at least 5%, at least 8%, or more preferably at least 10%, at least 12%, or even at least 15%, such as up to 25% of the total area of the inner end surface 38, including ranges having these values as endpoints, such as from 5% to 25%, from 5% to 20%, from 5% to 15%, from 10% to 25%, from 10% to 20%, from 10% to 15%, from 15% to 25% or from 15% to 20%.

In embodiments, an average velocity of the secondary air injected by the nozzle reaches an upstream face of the heater assembly such that an average velocity of the secondary air across the upstream face of the heater assembly is at least 70% of a maximum velocity at the upstream face of the heater assembly, such as at least 72%, at least 74%, at least 76%, or even at least 78%, and ideally up to 100%, including ranges having these values as endpoints, such as from 72% to 100%, from 74% to 100%, from 76% to 100%, and from 78% to 100%.

It will be apparent to those skilled in the art that various modifications and variations can be made without departing from the spirit or scope of the claimed subject matter. Accordingly, the claimed subject matter is not to be restricted except in light of the attached claims and their equivalents.

1. A secondary air injection system for an exhaust aftertreatment system, comprising:
a nozzle positioned within exhaust piping of the exhaust aftertreatment system, wherein the nozzle comprises:
a tubular side wall extending in a longitudinal direction and having a first inner width that defines a flow passage to direct secondary air through the nozzle in an axial flow direction that is parallel to the longitudinal direction, the first inner width extending in a lateral direction perpendicular to the axial flow direction;
an outlet end having an inner end surface within the flow passage that extends transversely with respect to the axial flow direction of the secondary air within the nozzle;
a first set of openings in the tubular side wall through which a first portion of the secondary air exits the nozzle in directions transverse to the axial flow direction; and
a second set of openings in the inner end surface through which a second portion of the secondary air exits from the nozzle in the axial flow direction;
wherein the inner end surface spans a second inner width in the lateral direction that is at least 50% of the first inner width.

2. The secondary air injection system of claim 1, wherein a flow rate of the secondary air through the nozzle is from 10 kg/h to 60 kg/h.

3. The secondary air injection system of claim 1, wherein a flow rate of the secondary air through the nozzle is from 20 kg/h to 45 kg/h.

4. The secondary air injection system of claim 1, wherein the inner end surface is a flat surface that extends perpendicularly to the axial flow direction.

5. The secondary air injection system of claim 1, wherein the second inner width of the inner end surface is equal to the first inner width.

6. The secondary air injection system of any one of claim 1, wherein the second set of openings occupies at least 5% of an inner area of the inner end surface at least partially by the second inner width.

7. The secondary air injection system of claim 1, wherein the second set of openings occupies at most 30% of an inner area of the inner end surface at least partially by the second inner width.

8. The secondary air injection system of claim 1, wherein the second set of openings occupies from 5% to 30% of an inner area of the inner end surface defined at least partially by the second inner width.

9. The secondary air injection system of claim 1, wherein the second set of openings occupies from 8% to 20% of an inner area of the inner end surface at least partially by the second inner width.

10. The secondary air injection system of claim 1, wherein the inner end surface comprises a central area having a third width in which none of the second set of openings are located.

11. The secondary air injection system of claim 10, wherein the third width of the central area is at least 25% of the first width.

12. The secondary air injection system of claim 10, wherein the third width of the central area is at least 30% of the first width.

13. The secondary air injection system of claim 10, wherein the third width of the central area is at least 40% of the second width.

14. The secondary air injection system of claim 10, wherein the third width of the central area is at least 50% of the second width.

15. The secondary air injection system of claim 1, wherein the system comprises a pump in fluid communication with ambient air that is configured to force the ambient air through the nozzle as the secondary air.

16. An exhaust aftertreatment system comprising the secondary air injection system of claim 1, a heater, and an aftertreatment component, wherein the heater is located downstream of the nozzle, and the aftertreatment component is located downstream of the heater.

17. The exhaust aftertreatment system of claim 16, wherein the aftertreatment component comprises a honeycomb body arranged as a particulate filter or catalyst substrate.

18. A method of uniformly providing heat to a downstream aftertreatment component in an exhaust aftertreatment system comprising:
injecting secondary air into exhaust piping of the exhaust aftertreatment system via a secondary air injection nozzle;
generating heat with a heater assembly of the exhaust aftertreatment system;
flowing the secondary air through the exhaust piping to the heater assembly to heat the secondary air with the heater; and
flowing the heated secondary air from the heater assembly to an aftertreatment component located downstream of the heater assembly to heat the aftertreatment component;
wherein an average velocity of the secondary air across an upstream face of the heater assembly is at least 70% of a maximum flow rate at the upstream face of the heater assembly.

19. The method of claim 18, wherein the secondary air injection nozzle comprises:
a nozzle positioned within exhaust piping of the exhaust aftertreatment system, wherein the nozzle comprises:
a tubular side wall extending in a longitudinal direction and having a first inner width that defines a flow passage to direct secondary air through the nozzle in an axial flow direction that is parallel to the longitudinal direction, the first inner width extending in a lateral direction perpendicular to the axial flow direction;
an outlet end having an inner end surface within the flow passage that extends transversely with respect to the axial flow direction of the secondary air within the nozzle;
a first set of openings in the tubular side wall through which a first portion of the secondary air exits the nozzle in directions transverse to the axial flow direction; and
a second set of openings in the inner end surface through which a second portion of the secondary air exits from the nozzle in the axial flow direction;
wherein the inner end surface spans a second inner width in the lateral direction that is at least 50% of the first inner width.

20. The method of claim 18, wherein the aftertreatment component comprises a honeycomb body arranged as a particulate filter or catalyst substrate.
